(19) United States
(12) Patent Application Publication
(10) Pub. No.: US 2004/0258869 A1
(43) Pub. Date: Dec. 23, 2004

(54) Modular plastic flooring

(76) Inventor: Alexander William Walker, Hemley Beach (AU)

Correspondence Address: Klauber & Jackson, Continental Plaza, 411 Hackensack Avenue, Hackensack, NJ, 07601, US

(21) Appl. No.: 10/501,313

(22) PCT Filed: Jan. 8, 2003
(86) PCT No.: PCT/AU03/00010

(30) Foreign Application Priority Data
Jan. 17, 2002 (AU) PR 9980

(51) Int. Cl. B32B 3/10

(52) U.S. Cl. 428/44; 52/177

(57) ABSTRACT

A modular plastic floor assembly formed from a plurality of shaped tiles (1) and a plurality of shaped connector tiles (3). The shape tiles are substantially larger than the shaped connector tiles and the shaped connector tiles fit into interstices between the shaped tiles when the floor assembly is formed. Each of the shaped tiles and the shaped connector tiles have a substantially planar upper surface (20) and a support array (5, 28) extending from a lower surface of the body. The shaped tiles have connectors (11) and the shaped connector tiles have complementary connectors (24). The connectors are adapted to interengage to interlock the shaped tiles to adjacent shaped connector tiles. Resiliently loaded fingers (118) allow for expansion and contraction between the adjacent tiles. The support array may include resiliently moulded shock absorbing portions (141). The upper surface may have in-mould decoration to provide a surface with changed appearance, frictional properties and/or surface hardness.

### FIELD OF INVENTION

This invention relates to plastic material tiles which are supported on a surface to provide a playing surface for recreational games and a temporary flooring surface for special events. More particularly the present invention pertains to modular tiles of plastic composition which are interlocked to form a playing surface.

### BACKGROUND TO THE INVENTION

A wide variety of floor coverings have been developed for use as playing surfaces for sports. Interlocking plastic tile floor coverings have grown in popularity due to their shock absorbent characteristics, which can help prevent injury to athletes, their versatility (can be indoor or outdoor) and affordability. Plastic flooring can also be quickly installed and removed for special events and sports competitions.

Structurally interlocked tile floor coverings generally comprise several interlocked plastic tiles in a grid like configuration. Each tile may have an underside provided with a rib arrangement and support legs extending from the ribs. The interlocking members typically comprise laterally extending connector members which are adapted to connect with corresponding members on adjacent tiles so as to connect the adjacent tiles together.

Although interlocking tile floors have grown in popularity because of their versatility, there have been problems during their use.

One problem is that square or rectangular tiles which are easy to lay out and to join together have provided long lines of joins which can deflect hockey pucks and balls traveling over the surface. Also square or rectangular tiles have become distorted which have caused corners of tiles to lift which can cause tripping problems for sports people.

It is an object of this invention to overcome at least some of these problems.

### BRIEF DESCRIPTION OF THE INVENTION

In one form therefore, although this may not necessarily be the only or broadest form, the invention is said to reside in a modular plastic floor assembly formed from a plurality of shaped tiles and a plurality of shaped connector tiles, the shaped tiles being substantially. larger than the shaped connector tiles and the shaped connector tiles being adapted to fit into interstices between the shaped tiles when the floor assembly is formed, each of the shaped tiles and the shaped connector tiles including a body having a substantially planar upper surface and a support array extending from a lower surface of the body, the support array being integrally formed with the body and comprising items having a common length such that their lower ends define a floor engaging plane, the shaped tiles having only a plurality of first connector means and the shaped connector tiles having only a plurality of complementary second type connector means, the first and second type connector means adapted to interengage to interlock the shaped tiles to adjacent shaped connector tiles.

Preferably the first and second type connector means are formed so that the shaped tiles and shaped connector tiles are spaced apart by a selected distance preferably 1 to 2 mm to take up shock load and thermal expansion and contraction.

There may be provided resiliently loaded fingers extending laterally on the shaped connector tiles to space the shaped tiles and shaped connector tiles apart. Such resiliently loaded fingers may be provided by integrally moulding plastic springs into the tiles. Alternatively the resiliently loaded fingers may be on the shaped tiles to engage against the connector tiles in use or there may be a combination of the loaded fingers provided on both the shaped tiles and the connector tiles sharing shock load and thermal expansion and contraction.

The support array may comprise a plurality of separated support walls which can be provided in a plurality of orientations such as triangles, squares or the like.

There may be further included a plurality of reinforcing structures under the body integrally formed with the body and being of lesser height than the common length and joining to the items having a common length.

Such reinforcing structures may for instance be squat cylinders or bosses.

The shaped tiles may be circular, octagonal, dodecagon shaped, triangular hexagon or other convenient shapes. The shaped connector tiles may be circular, octagonal, dodecagons, triangles or hexagons or the like to fit into the spaces between the shaped tiles.

The sides of the shaped tiles may be convex, straight or concave and the sides of the shaped connector tiles may be correspondingly convex, straight or concave.

The body may have apertures through it to allow water to drain off the upper surface so that the surface is not hazardous.

Each tile may have a perimeter wall extending to the floor engaging plane to provide good support around the edge of the tile.

The perimeter walls may include gaps to allow water drainage beneath the tiles.

In one preferred embodiment there may be female connector means on the shaped tiles and co-acting male connector means on the shaped connector tiles. Alternatively there may be male connector means on the shaped tiles and co-acting female connector means on the shaped connector tiles. The male connector means may include loops on one of the tiles which engage in female arcuate recesses in the underside of the other tile. There may also be included catch means or tabs associated with the loops to provide positive retention of the loops between the shaped and connector tiles.

The loop and arcuate recess connection method allows movement in the joint so that movement for thermal expansion and contraction can occur in the connection and the movement is absorbed by the resiliently loaded fingers adjacent the connection means.

The substantially planar upper surface may include radiused edges so that there is less danger of a user catching onto the edge of a tile during use.

There may be provided minor patterning such as spherical dimpling, photo chemically etched texture, electrical discharge machined texture or sand-blasted matte finish, on the upper surface of the shaped tiles and shaped connector tiles.

Alternatively the appearance such as pattern and colour, frictional properties such as texture or smoothness and surface hardness to give soft touch or scuff resistance of the upper surface of the shaped tiles and shaped connector tiles may be varied by adding a surface film to the shaped tile and shaped connector during the moulding process. This would preferably be done only to the visible top surface of the shaped tiles and shaped connector tiles plus the radiused edges. This process is known as “In-Mould Decoration”. This process would give the flexibility of radically changing the appearance and performance of the modular plastic floor assembly produced by the invention by only changing the surface film, while keeping the same tile structure under the film. For example, it would be possible to mould a plastic tiled floor with a hard, scuff resistant, wood grain finish.

It should be noted that there is no direct connection between the shaped tiles. All the connections go via the shaped connector tiles.

There may be provided, however, sliding projections on the unconnected edges of shaped tiles which interengage with slots in the walls of adjacent shaped tiles to prevent the unconnected edges from lifting up above adjacent edges of adjacent tiles.

The modular floor formed according to the present invention may include edge pieces which enable a straight edged floor to be formed.

In a further form the invention is said to reside in a modular plastic main floor tile including a body having a substantially planar upper surface and a support array extending from a lower surface of the body, the support array being integrally formed with the body and comprising items having a common length such that their lower ends define a floor engaging plane, the main tile having a plurality of only female connector means adapted to connect with male connector means on an adjacent connector tile.

Preferably the female connector comprises an arcuate recess and the arcuate recess may include catch means or tabs to provide positive retention of the male connector.

In a further form the invention is said to reside in a modular plastic floor connector tile including a body having a substantially planar upper surface and a support array extending from a lower surface of the body, the support array being integrally formed with the body and comprising items having a common length such that their lower ends define a floor engaging plane, the connector tile having a plurality of only male connector means adapted to connect with female connector means on an adjacent main tile.

Preferably the male connector means include a loop adapted to engage in a female arcuate recesses in the underside of the main tile.

With modular plastic flooring, it is known to use a sheet of rubber underlay under the surface to enhance its shock absorption (force reduction) characteristics when used in sporting applications. This is a separate component to the flooring system, which has to be laid independently and also an additional cost. This invention in a preferred embodiment proposes a shock absorption component which is integral to both the shaped tile and the shaped connector tile. This may be achieved by making the support array comprising a plurality of separated support walls composed of two materials, one component providing the rigid structural component of the floor and the other component providing a shock absorbent element and being the component which contacts the floor engaging plane. The rigid component may be made from a rigid plastic material and the shock absorbent element component may be made from a softer elastomeric material. One form of softer elastomeric material may be an elastomeric polyolefin.

It will be seen that by this invention there can be provided a modular sports flooring which when assembled has few continuous straight lines which could cause an obstruction and would limit the effective use of the tile floor surface over which a ball or hockey puck can easily travel.

The larger shaped tiles mean fewer edges which limit the effective use of the tile as a ball or hockey puck contacting surface. The larger shaped tiles also mean that fewer tiles are necessary to lay and therefore enabling quicker assembly and disassembly. It also means that there may be less distortion through differential thermal expansion and contraction, therefore, providing a flatter playing surface. There are also fewer lifting corners or edges which can create safety hazards.

Because the thermal expansion and contraction can be taken up at each connection, the overall dimensions of the floor remain substantially constant during changes in temperature.

### BRIEF DESCRIPTION OF THE DRAWINGS

This then generally describes the invention but to assist with understanding reference will now be made to the accompanying drawings which show preferred embodiments of the invention.

In the drawings:

FIG. 1 shows an arrangement of shaped tiles and shaped connector tiles according to one embodiment of the invention;

FIG. 2 shows a part view of the underside of a shaped tile;

FIG. 3 shows the underside view of a shaped connector tile;

FIG. 4 shows the upper side view of one embodiment of a shaped connector tile;

FIG. 5 shows an underside view of the connection region of an assembled shaped tile and shaped connector tile according to one embodiment of the invention with only a part of each of the shaped tile and the shaped connector tile shown;

FIG. 6 shows an underside perspective view of part of the assembled tiles shown in FIG. 5;

FIG. 7 shows the arrangement of a resiliently loaded finger on the underside of a tile of one embodiment of the invention;

FIG. 8 shows one view of sliding projections on unconnected edges of the shaped tiles according to one embodiment of the invention;

FIG. 9 shows an alternative view of the sliding projections on unconnected edges of the shaped tiles as shown in FIG. 8;

FIG. 10 shows an underside view of the sliding projections of FIG. 8 when two shaped tiles abut;

FIG. 11 shows a schematic view of the expansion absorption process of a modular floor assembly according to one embodiment of the invention;

FIGS. 12A to F show alternative configurations of shaped tiles and shaped connector tiles of the present invention;

FIGS. 13A to D show alternative embodiments of shaped connector tiles;

FIGS. 14 A and B show a part view of the upper and under sides of an alternative embodiment of a shaped connector tile with connection means and resiliently loaded finger configuration;

FIG. 15 shows part of the underside of an alternative embodiment of shaped tiles with its associated connector means;

FIG. 16 shows a further detail of the alternative connection means shown in FIG. 15;

FIG. 17 shows one possible arrangement of holes or apertures in the tiles.; and

FIG. 18 shows the under side of a portion of a tile showing one embodiment of a shock absorbing arrangement.

### DESCRIPTION OF PREFERRED EMBODIMENTS

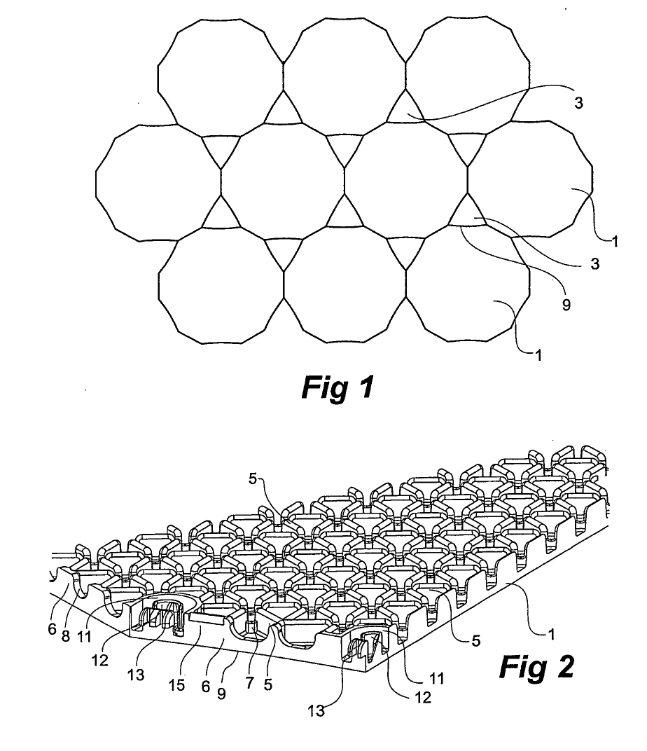

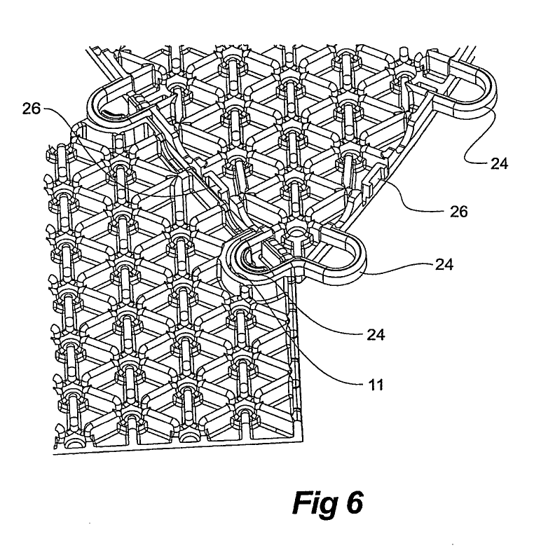

Now looking more carefully at the drawings and in particular a first preferred embodiment of the shaped tiles and shaped connector tiles and their methods of connection as shown in FIGS. 1 to 10.

In FIG. 1 it will be seen that the shaped tiles 1 are in the shape of a dodecagon with twelve sides but that six of the sides are slightly concave. Each shaped tile abuts with another shaped tile 1 but as will be discussed in relation to further drawings there are no connectors on these abutting faces. Connection is provided through a shaped connector tile 3 which is of a substantially triangular shape but with three convex sides. Each shaped connector tile 3 abuts three shaped tiles 1.

It will be noted that there are no long straight lines of join between the various tiles which if used would create a directional bias to give problems when playing sports on the floor.

In one preferred embodiment of the invention the diameter of the shaped tiles is 500 mm and there is a gap of approximately 1 mm to 2 mm between the tiles to take up thermal expansion and contraction as will be discussed in relation to later drawings.

FIG. 2 shows an underside view of part of a shaped tile 1.

Each tile comprises a body which has a substantially planar upper surface, side walls 6 extending down to a floor engaging plane and a support array extending from the lower surface. The support array comprises a triangulated rib configuration of ribs 5 which extend from bosses 7 which are shorter than the ribs 5. The bosses 7 are substantially circular. The use of a triangular ribbed structure is intended to provide more resistance to multi directional loading than a square ribbed structure.

The walls 6 have arcuate recesses 8 at intervals and the fibs 5 are discontinuous so as to allow for draining of water below the tiles.

The connection arrangement on the shaped tile is provided on that face 9 which in use is adapted to engage against a shaped connector tile. The connector arrangement includes a female semi-circular socket 11 and a locking tab 13.

The semi-circular recesses 11 also include a semi-circular stop arrangement 12 which engages into the loop on the shaped connector tile and prevents the connector from being pulled apart.

Between two connection sockets 11 is at least one abutment face 15 for receiving resiliently loaded fingers as will be discussed in relation to the shaped connector tiles.

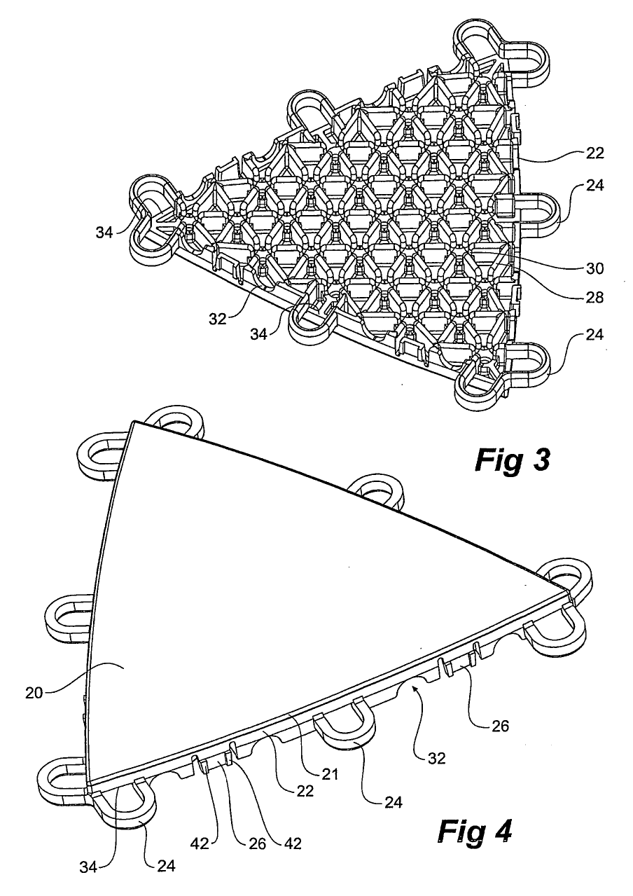

FIGS. 3 and 4 show an underside and top side view of a shaped connector tile according to one embodiment of this invention.

The shaped connector tile includes a planar upper surface 20 with side walls 22 extending down to a floor engaging plane and extending out from each side wall at least one loop shaped connector means 24. In this embodiment there are three loop shaped connector means on each side of each connector tile but other numbers of loop shaped connector means may also be used. Between each loop shaped connector means is a resiliently loaded finger arrangement 26 as will be discussed later.

In this embodiment the upper surface 20 and the radiused or bevelled edge 21 of the shaped connector tile between the upper surface 20 and the side wall 22 is formed by an in-mould decoration process to provide an upper surface which has changed properties to those of the material from which the shaped tiles and shaped connector tiles are manufactured. These properties may include appearance such as pattern and colour, frictional properties such as texture or smoothness and surface hardness to give soft touch or scuff resistance to the upper surface.

The upper surface and radiused or bevelled edge of the shaped tiles may also have changed properties by the use of an in-mould decoration process.

The underside of the shaped connector tile as shown in FIG. 3 also has a triangulated rib structure similar to that of the shaped tiles 1, with the rib structure incorporating ribs 28 all having a common length such that their lower ends define a floor engaging plane and bosses 30 of lesser height than the ribs with the ribs extending from and between the bosses. Once again the triangulated rib structure is intended to provide improved resistance to loading.

The wall 22 has arcuate apertures 32 at intervals to allow for drainage of water below the tiles.

Included within each loop shaped connector 24 is an abutment shoulder 34 against which is adapted to engage the connector tab 13 to hold the connection together when the loop 24 is inserted into the semi-circular recess 11 of the shaped tile 1.

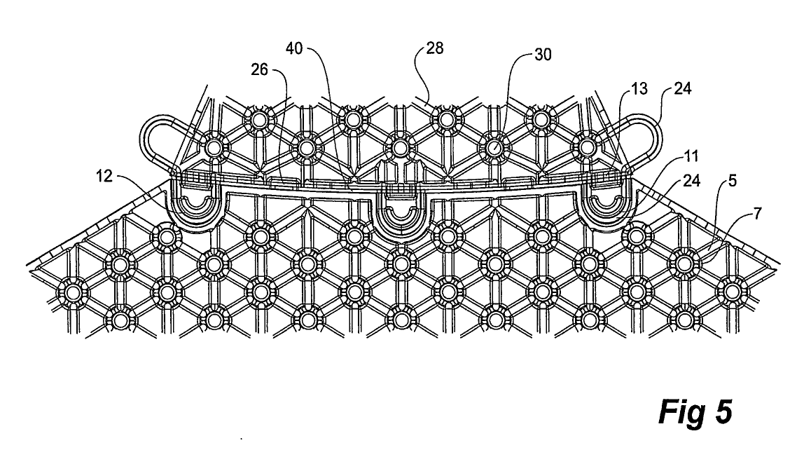

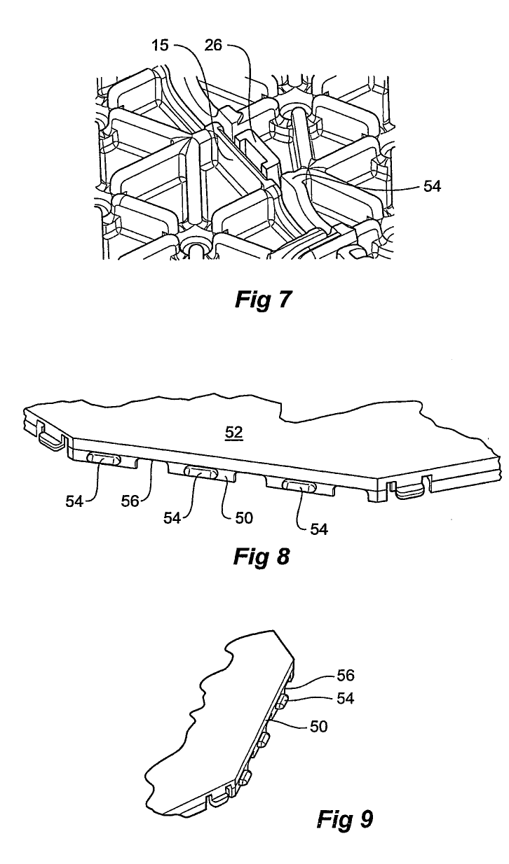

The connection of the shaped tile to the shaped connector tile is shown in FIG. 5. It will be noted that the loops 24 fit into the arcuate recesses 11 and that there is a gap 40 formed between the shaped tile and the shaped connector tile and this gap is held open by means of the resiliently loaded fingers 26. The resiliently loaded fingers are integrally formed with the wall 22 of the shaped connector tile and have projections 42 which engage against the wall portion 15 as can specifically be seen in FIG. 7 for instance.

With thermal expansion of the shaped tiles the gap between the tiles can dose but the resiliently loaded fingers keep tension in the gap and when cooling occurs the resiliently loaded fingers open up the gap and keep the connection tight.

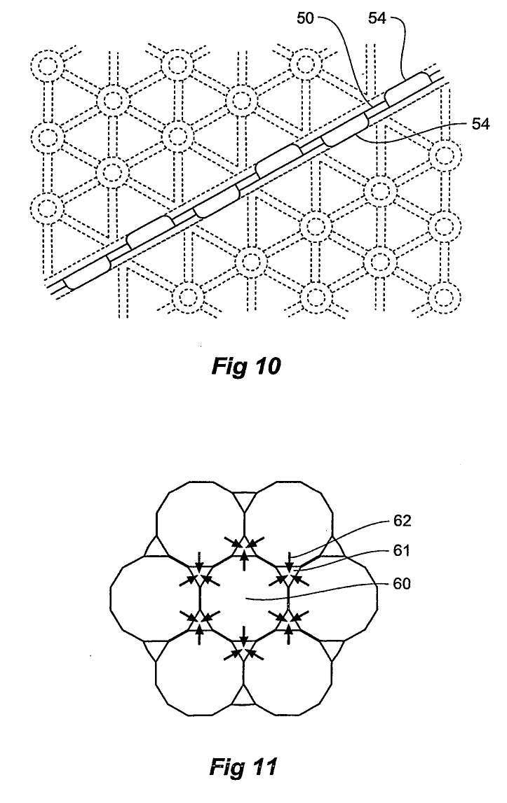

FIGS. 8, 9 and 10 show an alternative embodiment of a shaped tile which incorporates sliding projections on the unconnected edges of the tile which engage under the wall of adjacent shaped tiles to prevent the unconnected edges from lifting up above the adjacent tile. On the wall 50 of the tile 52 are a number of projections 54 and spaced between the projections are a number of recesses 56. When a shaped tile is abutted with another shaped tile the projections 54 of one tile extend into the recesses 56 in the other tile in both directions as can be seen in the underside view shown in FIG. 10 and this prevents one edge of a tile from lifting up with respect to the adjacent edge on another tile.

As can be seen in FIG. 11 the thermal expansion of a shaped tile 60 which is expected to extend in all directions substantially equally will be taken up by the gaps between the adjacent shaped tiles and by the resiliently loaded fingers between the shaped tiles and the shaped connector tiles. The expected lines of force are shown by the arrows 62. By this arrangement it is expected that the overall dimensions of a floor formed from the shaped tiles and shaped connector tiles of the present invention will not change with thermal expansion and contraction as the changes in dimensions will be taken up in every joint.

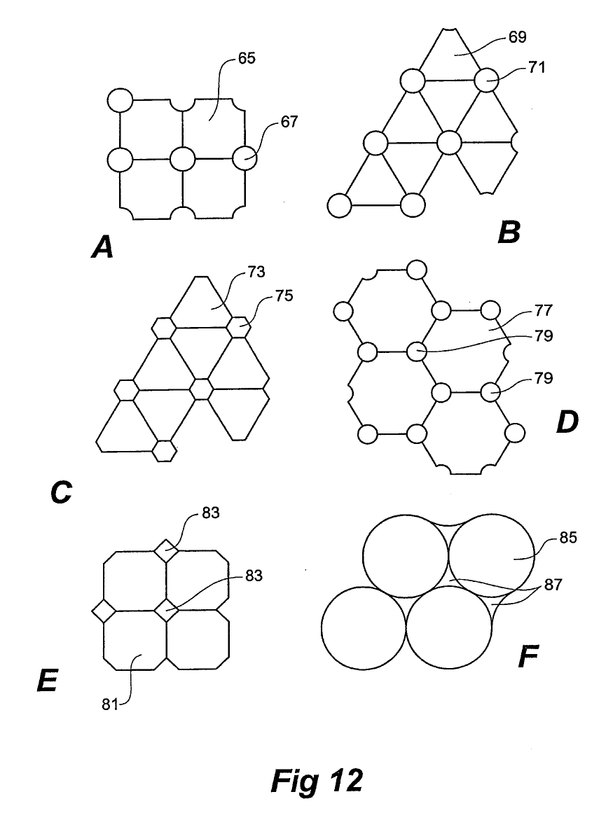

FIG. 12 shows a range of alternate shapes which can be used for the shaped connector tile and shaped tile according to alternative embodiments of the present invention.

FIG. 12A shows an embodiment with substantially octagonal tiles 65 and circular connector tiles 67.

FIG. 12B shows hexagonal shaped tiles 69 and circular connector tiles 71.

FIG. 12C shows hexagonal shaped tiles 73 and hexagonal connector tiles 75.

FIG. 12D shows dodecagonal shaped tiles 77 and circular connector tiles 79.

FIG. 12E shows substantially octagonal shaped tiles 81 and diamond shaped connector tiles 83.

FIG. 12F shows circular shaped tiles 85 with triangular connector tiles 87 with each of the sides of the triangular connector tiles being concave with substantially the same radius of curvature as the radius of the shaped tiles 85. The vertices of each connector tile 87 almost touch adjacent connector tiles, therefore allowing connector attachment to each shaped tile over substantially the full circumference of each shaped tile 85. It may be noted, too, that there are no straight lines which may interfere with a hockey puck or a ball travelling on the surface.

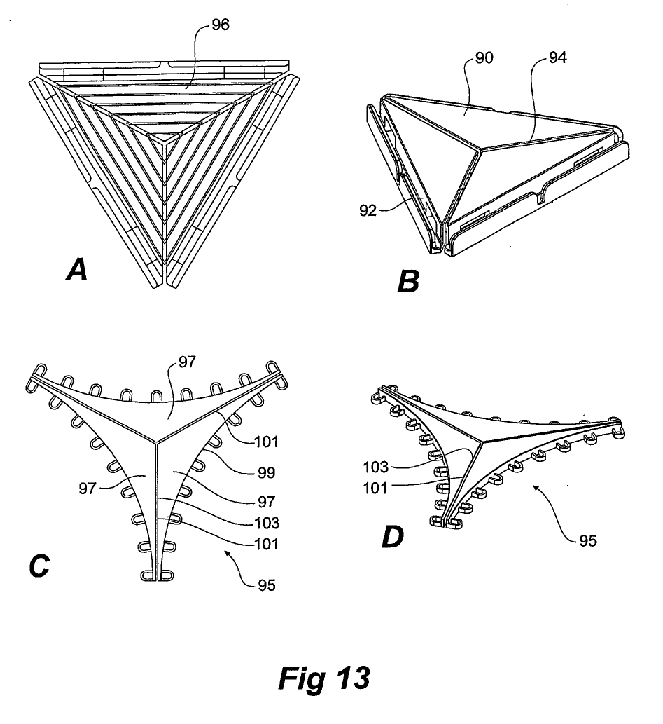

FIG. 13 shows various embodiments of shaped connector tiles specifically adapted to absorb expansion and contraction between adjacent shaped tiles.

FIGS. 13A and 13B show a first embodiment of alternative connector tiles. In this embodiment the connector tile is substantially triangular and has continuous connection recesses 92 on each of its sides and the adjacent shaped tile connects rigidly with the shaped connector tile. Thermal expansion and contraction is taken up in a Y-shaped slot 94 extending from each corner of the connector tile and meeting in the centre with integrally moulded resiliently loaded ribs 96 as can be seen in FIG. 13A showing the underside of the tile which provide resistance to the closure of the Y-shaped gap and hence the triangular shaped tile is adapted to take up thermal expansion and contraction.

In the embodiment shown in FIGS. 13C and 13D the shaped connector tile 95 is made up from three separate portions 97. Each portion has an arcuate side 99 which includes the connectors to connect it to an adjacent shaped tile and two straight edges 101. The adjacent straight edges on two of the shaped portions 97 are spaced apart by a compressible elastomer type material 103 so that a composite tile is formed. This compressible elastomer type material is adapted to take up the thermal expansion and contraction between the shaped tiles.

In an alternative embodiment the entire shape connector tile may be made from a compressible elastomer type material.

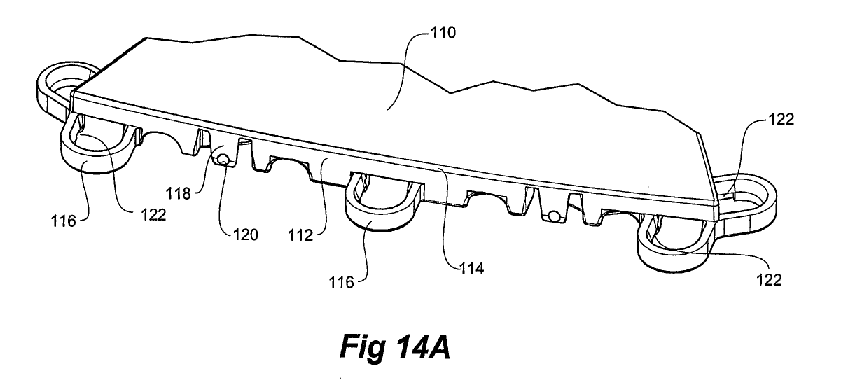

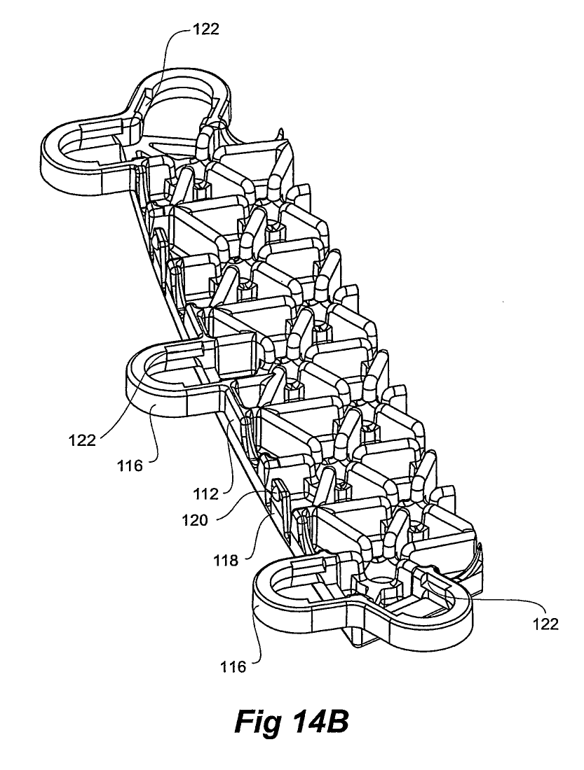

FIGS. 14 A and B, 15 and 16 show an alternative embodiment of connector and resiliently loaded finger arrangement according to the present invention.

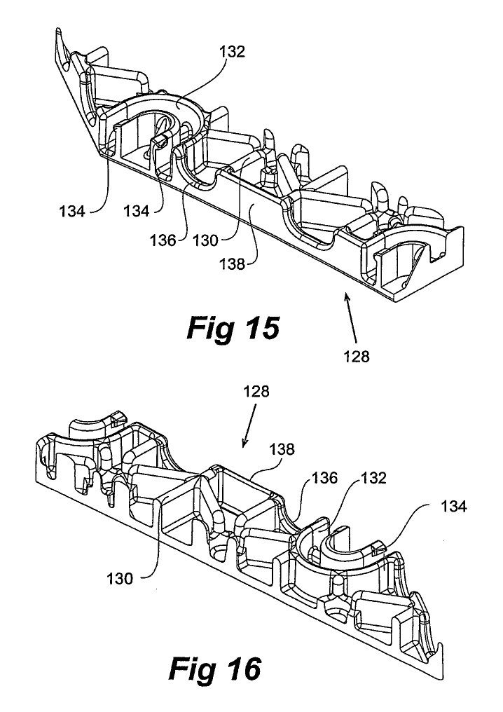

FIGS. 14 A and B show a part view of the upper and under sides of an alternative embodiment of a shaped connector tile with connection means and resiliently loaded finger configuration. As with the earlier embodiments the underside has a triangulated rib structure bounded by a peripheral wall 112. The tile has an upper surface 110 with the side wall 112 at the periphery and with a slight bevel 114 between them. Connector loops 116 extend from the wall 112 and are adapted to be received in semi-circular recesses in the shaped tiles as will be seen in FIGS. 15 and 16. The connector loops 116 have recesses 122 on their inner sides to accept the catches on the shaped tiles as will be discussed with reference to FIGS. 15 and 16. Between each connector loop 116 is a depending finger 118 which is integrally moulded with the shaped tile. A dome 120 on the finger 118 in effect extends out from the plane of the wall 112 to engage against the wall of the shaped tile. The dome 120 and finger 118 provide the resiliently loaded finger.

FIGS. 15 and 16 show a portion of the underside shaped tile. As with the earlier embodiments the underside has a triangulated rib structure 130 bounded by a peripheral wall 138. In the wall 138 of the shaped tile 128 is an arcuate recess 132 to receive the loop 116 of the connector tile and on the inner opening of the arcuate recess 132 at two positions 134 is a catch arrangement which is adapted to engage into the recesses 122 on the inner sides of the loops 116 on the connector tile 110. A feature of this type of clipping arrangement is that it's major axis of clipping, is the same direction as the sliding movement experienced during tile expansion and contraction, making it easier to unclip the tiles when the tiles are in their expanded condition. During expansion and contraction the loop moves longitudinally in the arcuate recess 132, that is, the loop moves in a direction perpendicular to the wall 138 so that thermal expansion and contraction can be absorbed at each connection. The wall 138 includes recesses 136 to allow water drainage underneath the tiles and provides an abutment surface for the dome 120 of the resiliently loaded finger.

As discussed earlier the tiles may have apertures in their surfaces to allow for water to drain off the surface if the tiles are used outdoors.

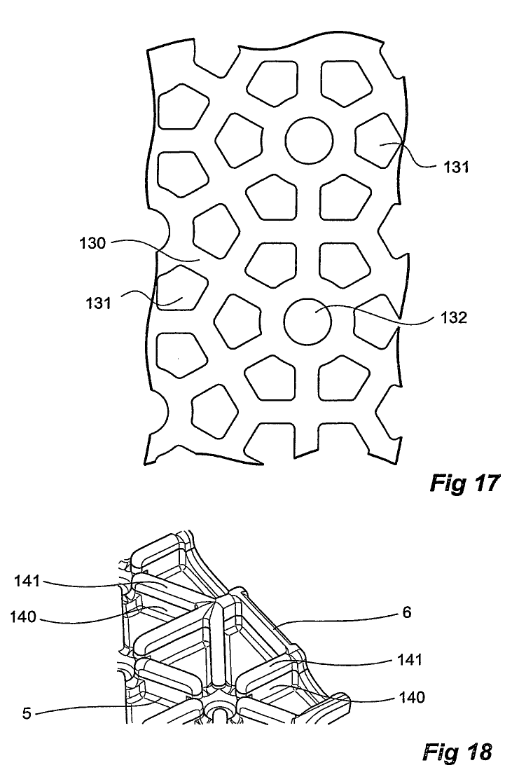

FIG. 17 shows one possible arrangement of holes or apertures in the tiles. The upper surface 130 has a pattern of circular and pentagonal apertures. The circular apertures 132 are aligned with apertures in the circular bosses 7 (see FIG. 2) and the pentagonal apertures 131 are aligned with the spaces between the ribs 5 (see FIG. 2).

FIG. 18 shows the underside of a portion of a tile showing one embodiment of a shock absorbing arrangement. As with earlier embodiments the underside of the tile has a support array extending from the lower surface. The support array comprises a triangulated rib configuration of ribs 5 and the side wall 6 but in this embodiment the ribs are formed from two components integrally moulded together. The base 140 of the ribs 5 and the side wall 6 is formed from the same material as the bulk of the tile and is preferably is made from a rigid plastic material and the tip 141 of the ribs 5 and the side wall 6 is made from a softer elastomeric material such as an elastomeric polyolefin. By this arrangement the necessity of having a separate rubber sheet underlay for sports flooring may be avoided.

Throughout this specification various indications have been given as to the scope of the invention but the invention is not limited to any one of these but may reside in two or more of these combined together. The examples are given for illustration only and not for limitation.

1. A modular plastic floor assembly formed from a plurality of shaped tiles and a plurality of shaped connector tiles, the shaped tiles being substantially larger than the shaped connector tiles and the shaped connector tiles being adapted to fit into interstices between the shaped tiles when the floor assembly is formed, each of the shaped tiles and the shaped connector tiles including a body having a substantially planar upper surface and a support array extending from a lower surface of the body, the support array being integrally formed with the body and comprising items having a common length such that their lower ends define a floor engaging plane, the shaped tiles having only a plurality of first connector means and the shaped connector tiles having only a plurality of complementary second type connector means, the first and second type connector means adapted to interengage to interlock the shaped tiles to adjacent shaped connector tiles.

2. A modular plastic floor assembly as in claim 1 wherein the first and second type connector means are formed so that the shaped tiles and shaped connector tiles are spaced apart by a distance of from 1 to 2 mm to take up shock load and thermal expansion and contraction.

3. A modular plastic floor assembly as in claim 1 further including resiliently loaded fingers extending laterally from the shaped connector tiles to space the shaped tiles and shaped connector tiles apart.

4. A modular plastic floor assembly as in claim 3 wherein the resiliently loaded fingers include integrally moulding plastic springs.

5. A modular plastic floor assembly as in claim 1 further including resiliently loaded fingers extending laterally from the shaped tiles to space the shaped tiles and shaped connector tiles apart.

6. A modular plastic floor assembly as in claim 5 wherein the resiliently loaded fingers include integrally moulding plastic springs.

7. A modular plastic floor assembly as in claim 1 wherein the support array includes a plurality of separated support walls.

8. A modular plastic floor assembly as in claim 1 further including a plurality of reinforcing structures under the body integrally formed with the body and being of lesser height than the common length and joining to the items having a common length.

9. A modular plastic floor assembly as in claim 8 wherein the reinforcing structures are squat cylinders or bosses.

10. A modular plastic floor assembly as in claim 1 wherein the shaped tiles are formed in a shape selected from circular, octagonal, dodecagon shaped, triangular hexagon or other convenient shapes.

11. A modular plastic floor assembly as in claim 1 wherein the shaped connector tiles are formed in a shape selected from circular, octagonal, dodecagons, triangles or hexagons or the like to fit into spaces between the shaped tiles.

12. A modular plastic floor assembly as in claim 1 wherein the sides of the shaped tiles are formed in a shape selected convex, straight or concave and the sides of the shaped connector tiles are correspondingly concave, straight or convex.

13. A modular plastic floor assembly as in claim 1 wherein the body has apertures through it to allow water to drain off the upper surface.

14. A modular plastic floor assembly as in claim 1 wherein each tile has a perimeter wall extending to the floor engaging plane to provide good support around the edge of the tile.

15. A modular plastic floor assembly as in claim 14 wherein the perimeter walls include gaps to allow water drainage beneath the tiles.

16. A modular plastic floor assembly as in claim 1 including female connector means on the shaped tiles and co-acting male connector means on the shaped connector tiles.

17. A modular plastic floor assembly as in claim 1 including male connector means on the shaped tiles and co-acting female connector means on the shaped connector tiles.

18. A modular plastic floor assembly as in claim 16 or claim 17 wherein the male connector means include loops on one of the tiles which engage in female arcuate recesses in the underside of the other tile.

19. A modular plastic floor assembly as in claim 18 wherein the female arcuate recesses include catch means or tabs to provide positive retention of the loops in the arcuate recesses.

20. A modular plastic floor assembly as in claim 1 wherein the upper surface of both the shaped tiles and shaped connector tiles includes minor patterning selected from spherical dimpling, photo chemically etched texture, electrical discharge machined texture or sand-blasted matte finish.

21. A modular plastic floor assembly as in claim 1 further including sliding projections on the unconnected edges of shaped tiles which interengage with slots in the walls of adjacent shaped tiles to prevent the unconnected edges from lifting up above adjacent edges of adjacent tiles.

22. A modular plastic floor assembly as in claim 1 further including edge pieces to engage with shaped tiles and shaped connector tiles to enable a straight edged floor to be formed.

23. A modular plastic floor assembly as in claim 1 wherein the plurality of separated support walls are composed of two materials, one material providing a rigid structural component of the tiles and the other material providing a shock absorbent element and being the portion which defines the floor engaging plane.

24. A modular plastic floor assembly as in claim 1 wherein the substantially planar upper surface includes a surface film provided by in-mould decoration to provide a surface with changed appearance, frictional properties and/or surface hardness.

25. A modular plastic main floor tile adapted for use with a substantially smaller connector tile, the main tile including a body having a substantially planar upper surface and a support array extending from a lower surface of the body, the support array being integrally formed with the body and comprising items having a common length such that their lower ends define a floor engaging plane, the main tile having a plurality of only female connector means adapted to connect with male connector means on an adjacent connector tile.

26. A modular plastic main floor tile as in claim 25 wherein the female connector comprises an arcuate recess.

27. A modular plastic main floor tile as in claim 25 wherein the arcuate recess includes catch means or tabs to provide positive retention of the male connector.

28. A modular plastic main floor tile as in claim 25 further including resiliently loaded fingers extending laterally from the tile to space the tiles from an adjacent connector tile.

29. A modular plastic main floor tile as in claim 25 wherein the support array includes a plurality of separated support walls.

30. A modular plastic main floor tile as in claim 25 wherein the tile is formed in a shape selected from circular, octagonal, dodecagon shaped, triangular hexagon or other convenient shapes.

31. A modular plastic main floor tile as in claim 25 wherein the support array includes a plurality of separated support walls composed of two materials, one material providing a rigid structural component of the tiles and the other material providing a shock absorbent element and being the portion which defines the floor engaging plane.

32. A modular plastic main floor tile as in claim 25 wherein the substantially planar upper surface includes a surface film provided by in-mould decoration to provide a surface with changed appearance, frictional properties and/or surface hardness.

33. A modular plastic floor connector tile adapted for use with a substantially larger main tile, the connector tile including a body having a substantially planar upper surface and a support array extending from a lower surface of the body, the support array being integrally formed with the body and comprising items having a common length such that their lower ends define a floor engaging plane, the connector tile having a plurality of only male connector means adapted to connect with female connector means on an adjacent main tile.

34. A modular plastic floor connector tile as in claim 33 wherein the male connector means include a loop adapted to engage in a female arcuate recesses in the underside of the main tile.

35. A modular plastic floor connector tile as in claim 33 further including resiliently loaded fingers extending laterally from the tile to space the connector tile from an adjacent main tile.

36. A modular plastic floor connector tile as in claim 33 wherein the support array includes a plurality of separated support walls.

37. A modular plastic floor connector tile as in claim 33 wherein the connector tile is formed in a shape selected from circular, octagonal, dodecagon, triangle or hexagon or the like to fit into spaces between the main tiles.

38. A modular plastic floor connector tile as in claim 33 wherein the support array includes a plurality of separated support walls composed of two materials, one material providing a rigid structural component of the tiles and the other material providing a shock absorbent element and being the portion which defines the floor engaging plane.

39. A modular plastic floor connector tile as in claim 33 wherein the substantially planar upper surface includes a surface film provided by in-mould decoration to provide a surface with changed appearance, frictional properties and/or surface hardness.
